(19) United States
(12) Patent Application Publication
(10) Pub. No.: US 2003/0101285 A1
(43) Pub. Date: May 29, 2003

(54) Control interface card adapted for auto-reloading object position data, comparing object position data, and providing a triggering signal

(76) Inventors: Yi-Tun Huang, Hsinchu City (TW); Sheng-Fu Chang, Changhua City (TW); Tsan-Ming Yu, Taoyuan City (TW)

Correspondence Address: Eugene Mar, BACON & THOMAS, PLLC, Fourth Floor, 625 Slaters Lane, Alexandria, VA, 22314-1176, US

(21) Appl. No.: 09/994,726

(22) Filed: Nov. 28, 2001

(51) Int. Cl. G06F 9/44; G06F 3/00

(52) U.S. Cl. 709/315; 710/36

(57) ABSTRACT

A control interface card is constructed to include a bus controller connected to the CPU of a host computer, a data buffer adapted for registration of object position data computed by the CPU of the host computer, a position compare circuit adapted for fetching registered object position data from the data buffer and comparing the fetched object position data with feedback position data obtained from an object shifting control means, and then fetching a next registered object position data from the data buffer for a next comparison after matching of one comparison, and a trigger I/O circuit adapted for providing a triggering signal to the CPU of the host computer upon matching of one comparison at the position compare circuit.

### BACKGROUND OF THE INVENTION

The present invention relates to a control interface card adapted for use with the CPU of a host computer and, more particularly to a control interface card adapted for auto-reloading object position data, comparing registered object position data with feedback object position data, and providing a triggering signal to the CPU of the host computer when a comparison matched.

When an industrial computer proceeding with a continuous motion position comparison (for example, fixed-position photographing), the CPU (central processing unit) of the computer is controlled to set one object position data into a position compare circuit for comparison with a feedback position data. When the comparison matched, the position compare circuit gives a signal to the CPU, causing the CPU to provide a next object position data for comparison. This action is repeated again and again. Further, this action can be applied to a counter or the like. However, the CPU may simultaneously proceed with various system handling and computing tasks during the operation of the industrial computer. When reloading new object position data, the CPU will spend extra computing time. This extra task may affect the operation of the CPU in proceeding with other system handling and computing tasks. Furthermore, due to software and operation system design differences, it is difficult to estimate the whole object position data reloading time.

### SUMMARY OF THE INVENTION

The present invention has been accomplished to provide a control interface card, which eliminates the aforesaid drawbacks. It is therefore the main object of the present invention to provide a A0 control interface card, which has a data buffer for registration of object position data so that the position compare circuit can directly fetch registered object position data for comparison with feedback position data without through the CPU of the host computer.

According to the present invention, the control interface card (for example, PCI-8164) comprises a bus controller connected to the CPU of a host computer, a data buffer adapted for registration of object position data computed by the CPU of the host computer, a position compare circuit adapted for fetching registered object position data from the data buffer and comparing the fetched object position data with feedback position data obtained from an object shifting control means, and then fetching a next registered object position data from the data buffer for a next comparison after matching of one comparison, a trigger I/O circuit adapted for providing a triggering signal to the CPU of the host computer upon matching of one comparison at the position compare circuit, and a bus arbitrator connected to the bus controller and adapted for providing an interrupt signal to the CPU of the host computer through the bus controller upon matching of one comparison at the position compare circuit.

### BRIEF DESCRIPTION OF THE DRAWINGS

FIG. 1 is a schematic drawing showing the system architecture of the present invention.

FIG. 2 is a system block diagram showing the architecture of the present invention.

FIG. 3 is a flow chart explaining the action of the CPU to store object position data in the data buffer according to the present invention.

FIG. 4 is a flow chart explaining the functioning of the position compare circuit according to the present invention.

### DETAILED DESCRIPTION OF THE PREFERRED EMBODIMENT

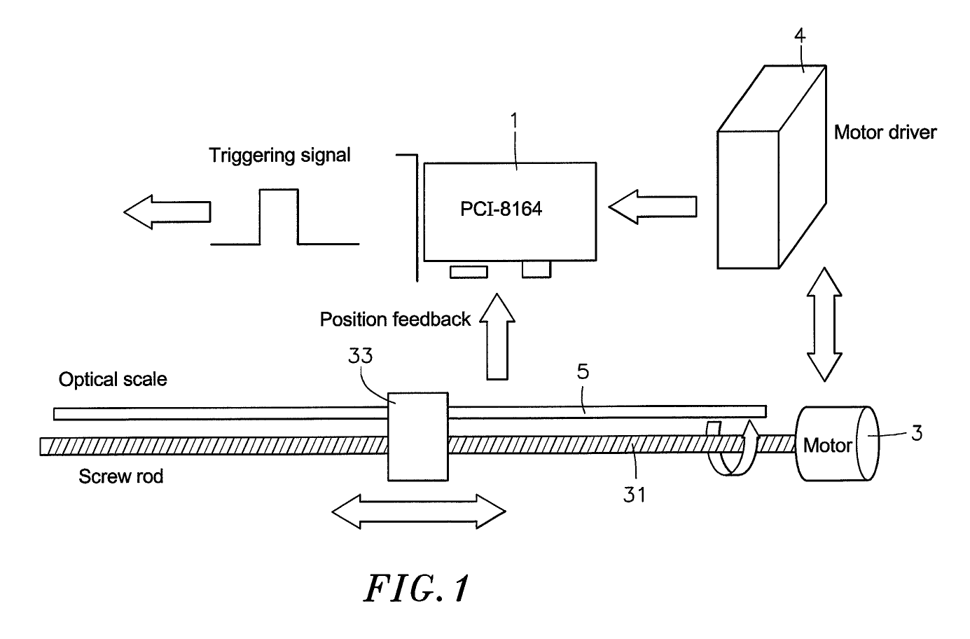

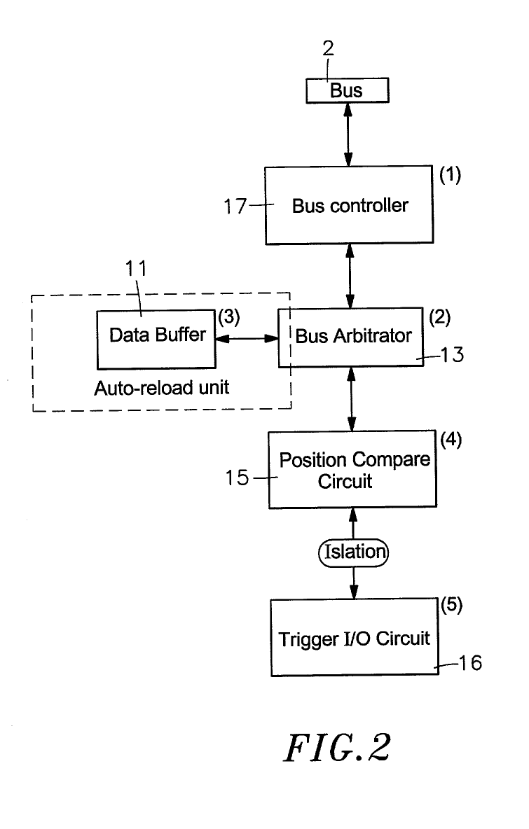

Referring to FIGS. 1 and 2, a control interface card 1 (for example PCI-8164 motion control card) is shown comprising a data buffer 11, bus arbitrator 13, a position compare circuit 15, a trigger I/O circuit 16, and a bus controller 17. The data buffer 11 is adapted for registration of object position data computed by the CPU (central processing unit) of the host computer (not shown). The position compare circuit 15 is adapted for comparing feedback position data with the object position data fetched from the data buffer 11. When matched after the comparison of the feedback position data with the fetched object position data, the position compare circuit 15 fetches another object position data from the data buffer 11 for another comparison. The bus controller 17 of the control interface card 1 is connected to the bus 2 of the host computer for intercommunication between the CPU of the host computer and the control interface card 1. The position compare circuit 15 proceeds with the following actions after the comparison of the feedback position data with one object position data fetched from the data buffer 11:

(1) sending a triggering signal to the trigger I/O circuit 16;

(2) sending an interrupt signal to the host computer to prompt the user; and

(3) fetching a next object position data from the data buffer 11.

Further, the CPU of the host computer stores computed object position data in the data buffer 11 via the bus 2, the bus controller 17, and the bus arbitrator 13. The trigger I/O circuit 16 converts the triggering signal from the position compare circuit 15 into a pulse signal of fixed bandwidth for output to the outside of the control interface card 1. The bus arbitrator 13 controls the circulation of data among the bus controller 17, the data buffer 11, and the position compare circuit 15, and protects the circulated data.

Referring to FIG. 1 again, the position feedback data can be obtained from the optical scale 5 or the motor driver 4. When started the motor 3 to rotate the screw rod 31, the object is shifted leftwards or rightwards, and the position of the object is measured by the optical scale 5 or the motor driver 4 and fed back to the position compare circuit 15 for comparison with the object position data fetched from the data buffer 11. When matched, the trigger I/O circuit 16 outputs a triggering signal (a pulse signal of a fixed bandwidth) to the external device to which the control interface card 1 is connected.

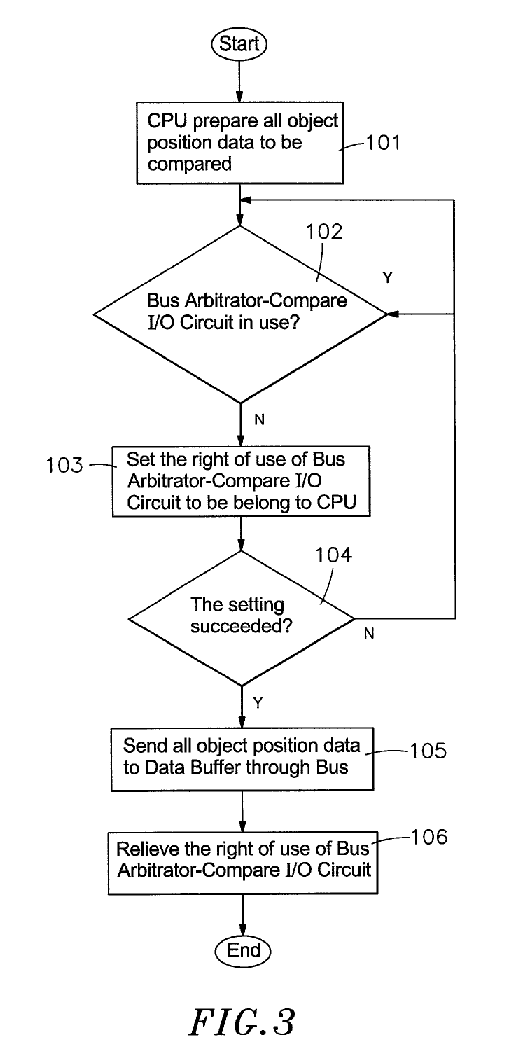

FIG. 2 is a block diagram showing the architecture of the present invention. FIG. 3 is a flow chart explaining the action of the CPU to store object position data in the data buffer. The procedure of storing object position data in the buffer includes the steps of:

(101) driving the CPU to compute all object position data to be compared;

(102) checking if the segment from the bus arbitrator 13 to the position compare circuit 15 is in use or not (when in use, it means that the position compare circuit 15 is fetching a new object position data from the data buffer)?, and then repeating step (102) if positive, or proceeding to the next step if negative;

(103) setting the right of using the segment from the bus arbitrator 13 to the data buffer 11 to be belong to the CPU;

(104) judging if the setting succeeded or not? and then proceeding to the next step if positive, or returning to step (102) if negative;

(105) transmitting all object position data through the bus 2, the bus controller 17, and the bus arbitrator 13 to the data buffer 11, enabling the object position data to be registered in the data buffer 11; and

(106) relieving the power of using the segment from the bus arbitrator 13 to the data buffer 11, and then ending the procedure.

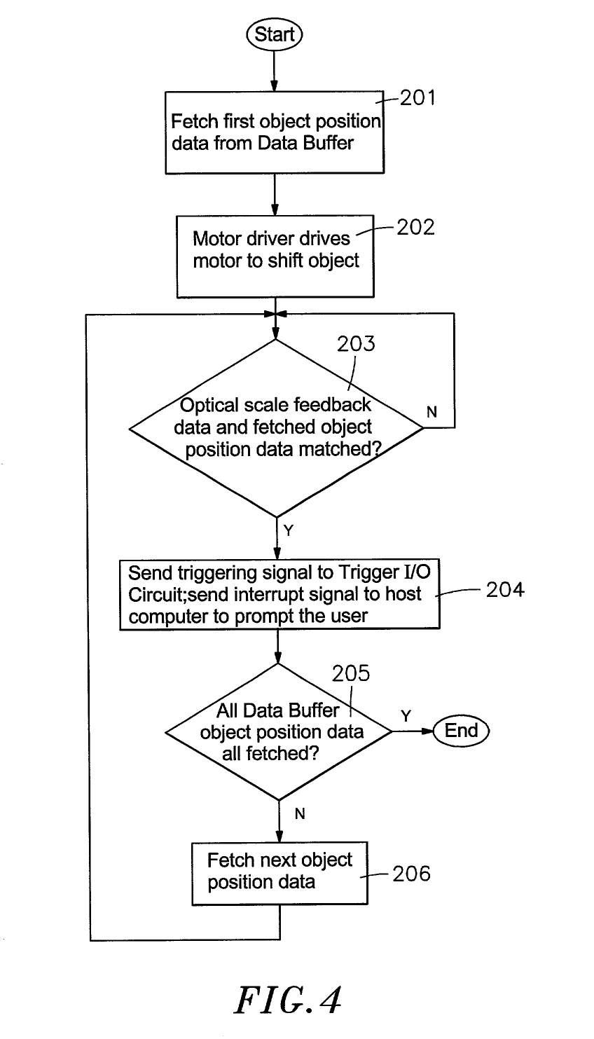

Referring to FIG. 4 and FIGS. 1 and 2 again, after registration of object position data in the data buffer 11 by the CPU, the position compare circuit 15 runs the following steps:

(201) fetching the first object position data from the data buffer 11;

(202) rotating the motor 3 to shift the object, and feeding back the data of the position of the object to the position compare circuit 15 for comparison during shifting;

(203) driving the position compare circuit 15 to compare the feedback data of the position of the object 33 obtained from the optical scale 5 or the motor driver 4 with the object position data fetched from the data buffer 11, and then proceeding to the next step if the data matched, or repeating step (203) if the data not matched;

(204) sending a triggering signal to the trigger I/O circuit 16, and providing an interrupt signal to the host computer;

(205) judging if the object position data registered in the data buffer 11 have all been fetched and compared, and then ending the procedure is positive, or proceeding to the next step if negative; and

(206) fetching the next object position data from the data buffer and then proceeding to step (203).

By means of the functioning of the control interface card 1, the CPU achieves high speed and accurate position comparing and triggering operation.

The aforesaid control interface card 1 can be a motion control interface card, or an industrial counting interface card. Further, the bus controller 17 and the bus 2 can be of PCI-BUS, ISA, Compact PCI, PC-104, or any suitable interface means capable of making communication with the related peripheral devices.

A prototype of object position data auto-reloading, comparing, triggering system has been constructed with the features of the annexed drawings of FIGS. 1˜4. The object position data auto-reloading, comparing, triggering system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A control interface card connected to the CPU (central processing unit) of a host computer and adapted for auto-reloading object position data, comparing object position data, and providing a triggering signal to the CPU of the host computer, said control interface card comprising a data buffer adapted for registration of object position data computed by the CPU of said host computer, a position compare circuit adapted for fetching registered object position data from said data buffer and comparing the fetched object position data with feedback position data obtained from an object shifting control means, and then fetching a next registered object position data from said data buffer for a next comparison after matching of one comparison, and a trigger I/O circuit adapted for providing a triggering signal to the CPU of said host computer upon matching of one comparison at said position compare circuit.

2. The control interface card as claimed in claim 1, which is a motion control interface card.

3. The control interface card as claimed in claim 1, which is an industrial counting interface card.

4. The control interface card as claimed in claim 1 further comprising a bus controller connected to a bus at the CPU of said host computer for intercommunication between the control interface card and the CPU of said host computer, and a bus arbitrator connected to said bus controller and adapted for providing an interrupt signal to the CPU of said host computer through said bus controller upon matching of one comparison at said position compare circuit.
